(19) United States
(12) Patent Application Publication
(10) Pub. No.: US 2014/0117755 A1
(43) Pub. Date: May 1, 2014

(54) POWER SYSTEM

(71) Applicant: HON HAI PRECISION INDUSTRY CO., LTD., New Taipei (TW)

(72) Inventors: KAI-FU CHEN, New Taipei (TW); CHIEN-SEN HSU, New Taipei (TW); CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/062,915

(22) Filed: Oct. 25, 2013

(30) Foreign Application Priority Data
Oct. 29, 2012 (TW) 101139993

(51) Int. Cl. H02J 1/10

(52) U.S. Cl. CPC H02J 1/102
USPC 307/22

(57) ABSTRACT

A power system for supplying direct current (DC) voltage to a load requiring same includes a main power supply outputting a first alternating current (AC) power, an auxiliary power supply outputting a first DC power directly, and a bidirectional power factor correction device. When the bidirectional power factor correction determines that the first DC power is more than a rate power of the load, the auxiliary power supply outputs only a first part of the first DC power to the load, and outputs a second part to the bidirectional power factor correction. The bidirectional power factor correction converts the second part into a second DC power, and redirects the second DC power into the main power supply. The first part of the first DC power output allowed into the load equals to the rated power of the load.

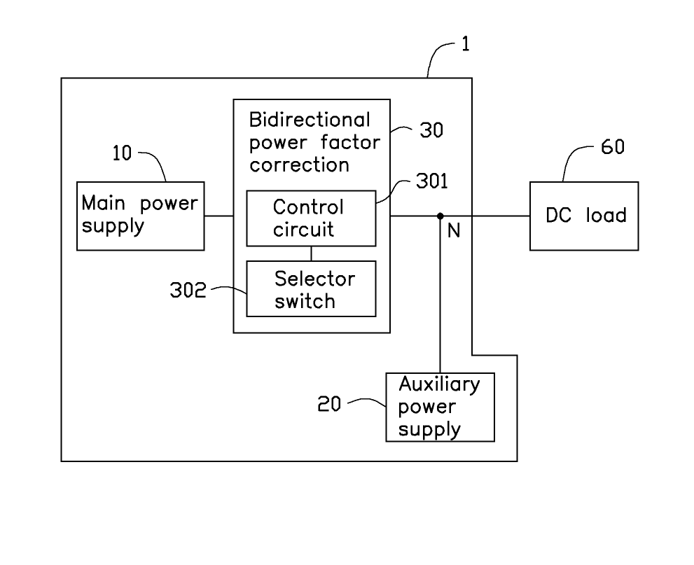

### BACKGROUND

1. Technical Field

The present disclosure relates to a power system, and particularly to a power system for supplying direct current (DC) to a load.

2. Description of Related Art

A main power system and an auxiliary power system are used to supply direct current (DC) voltages to loads. The main power system converts a high voltage alternating current (AC) voltage from a main power grid into a first DC voltage. The auxiliary power system utilizes green (renewable) energy, such as solar energy, or wind energy, to supply a second DC voltage. The auxiliary power system has priority over the main power system to supply the second DC voltage to the load.

If the auxiliary power system cannot supply sufficient power for the load, the main power system starts to output the first DC voltage, so as to cooperate with the auxiliary power system to supply enough power to the load(s). However, if the power generated by the auxiliary power system is more than rated power of the load, excess power from the auxiliary power system may make the loads unstable, or even damage components in the load.

Therefore, what is needed is a system and method that can overcome the described limitations.

### BRIEF DESCRIPTION OF THE DRAWINGS

The FIGURE is a schematic structural diagram illustrating one embodiment of a power system according to the present disclosure.

### DETAILED DESCRIPTION

Reference will now be made to the drawing to describe specific exemplary embodiments of the present disclosure.

The FIGURE is a schematic structural diagram illustrating one embodiment of a power system 1 according to the present disclosure. The power system 1 is configured to supply power to a load 60, which requires direct current (DC). The power system 1 includes a main power supply 10, an auxiliary power supply 20 and a bidirectional power factor correction 30. The main power supply 10 is connected to the load 60 via the bidirectional power factor correction 30. The bidirectional power factor correction 30 and the load 60 cooperatively define a node N therebetween. The auxiliary power supply 20 is connected to the node N.

The main power supply 10 supplies alternating current (AC) voltage to the bidirectional power factor correction 30. The AC voltage may be converted from non-renewable energy by the main power supply 10. The non-renewable energy may be oil or coal for example. The auxiliary power supply 20 supplies a first DC voltage to the load 60. The first DC voltage may be converted from renewable energy by the auxiliary power supply 20. The renewable energy may be wind energy or solar energy for example. The bidirectional power factor correction 30 receives the AC voltage from the main power supply 10, converts the AC voltage into a second DC voltage, and can output the second DC voltage to the load 60.

The bidirectional power factor correction 30 has a first mode for converting a DC power into an AC power and a second mode for converting an AC power into a DC power. The bidirectional power factor correction 30 includes a control circuit 301 and a selector switch 302 connected to the control circuit 301. The control circuit 301 compares a first DC power output from the auxiliary power system 20 with a rated power of the load 60, and controls the bidirectional power factor correction 30 to switch between the first mode and the second mode by controlling the selector switch 302, based on a comparison.

When the control circuit 301 determines that the first DC power is more than the rated power of the load 60, the control circuit 301 controls the bidirectional power factor correction 30 to switch to the first mode by controlling the selector switch 302. Accordingly, the auxiliary power system 20 outputs a first part of the first DC power to the load 60, and outputs a second part of the first DC power to the bidirectional power factor correction 30. The first part of the first DC power output to the load 60 equals the rated power of the load 60.

The bidirectional power factor correction 30 receives the second part of the first DC power output from the auxiliary power system 20, converts the second part of the first DC power into a first AC power, and transfers the first AC power to the main power supply 10. The main power supply 10 stores the first AC power from the bidirectional power factor correction 30. A phase of the AC voltage output from the main power supply 100 is opposite to a phase of an AC output from the main power supply 100, when the bidirectional power factor correction 30 is in the first mode.

When the control circuit 301 determines that the first DC power output from the auxiliary power system 20 is less than or equals the rated power of the load 60, the control circuit 301 controls the bidirectional power factor correction 30 to switch to the second mode from the first mode by controlling the selector switch 302. Accordingly, the bidirectional power factor correction 30 receives a second AC power from the main power supply 10, converts the second AC power into a second DC power, and outputs the second DC power to the load 60, such that a sum of the second DC power and the first DC power equals the rated power of the load 60. The phase of the AC voltage output from the main power supply 100 is identical with the phase of an AC output from the main power supply 100, when the bidirectional power factor correction 30 is in the second mode.

Since the bidirectional power factor correction 30 is capable of converting the second part of the first DC power (the excess of power) into the first AC power, and redirects the first AC power to the main power supply 10, the voltage fed to the load 60 is always stable, and components of the load 60 are not subjected to an overvoltage or overcurrent.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A power system configured to supply direct current (DC) power to a load, comprising:
a main power supply supplying a first alternating current (AC) power;
an auxiliary power supply connected to the load and supplying a first DC power to the load;
a bidirectional power factor correction connected between the main power supply and the auxiliary power supply, comparing the first DC power with a rate power of the load, and switching between a first mode for converting a DC power into an AC power and a second mode for converting an AC power into a DC power based on the comparison;
wherein when the bidirectional power factor correction determines that the first DC power is more than the rate power of the load, the bidirectional power factor correction switches to the first mode; the auxiliary power supply supplies a first part of the first DC power to the load, and supplies a second part of the first DC power to the bidirectional power factor correction; the bidirectional power factor correction converts the second part of the first DC power into a second AC power, and stores the second AC power to the main power supply; the first part of the first DC power output to the load equals the rate power of the load.

2. The power system of claim 1, wherein when the bidirectional power factor correction determines that the first DC power is less than or equal to the rate power of the load, the bidirectional power factor correction switches to the second mode; the main power supply supplies the first AC power to the bidirectional power factor correction; the bidirectional power factor correction converts the first AC power into a second DC power, and outputs the second DC power to the load; the auxiliary power supply supplies the first DC power to the load.

3. The power system of claim 2, wherein a sum of the first DC power and the second DC power equals to the rated power of the load when the bidirectional power factor correction is in the second mode.

4. The power system of claim 3, wherein the bidirectional power factor correction comprises a control circuit and a selector switch connected to the circuit; the control circuit compares the first DC power with the rate power of the load, and controls the bidirectional power factor correction to switch between the first mode and the second mode via controlling the selector switch, based on the comparison.

5. The power system of claim 4, wherein a phase of an AC voltage output from the main power supply is opposite to a phase of an AC output from the main power supply, when the bidirectional power factor is in the first mode.

6. The power system of claim 5, wherein the phase of the AC voltage output from the main power supply is identical with the phase of an AC output from the main power supply, when the bidirectional power factor correction in the second mode.

7. The power system of claim 1, wherein the auxiliary power supply directly outputs first DC power.
